(19) United States
(12) Patent Application Publication
(10) Pub. No.: US 2009/0031763 A1
(43) Pub. Date: Feb. 5, 2009

(54) Shipping container locking assembly

(76) Inventor: Ole Henrik Nielsen, Hong Kong (CN)

Correspondence Address: CHRISTIE, PARKER & HALE, LLP, PO BOX 7068, PASADENA, CA, 91109-7068, US

(21) Appl. No.: 11/982,515

(22) Filed: Oct. 31, 2007

Related U.S. Application Data
(60) Provisional application No. 60/963,276, filed on Aug. 2, 2007.
(60) Provisional application No. 60/967,927, filed on Sep. 7, 2007.

(51) Int. Cl. E05B 65/48

(52) U.S. Cl. 70/2

(57) ABSTRACT

Shipping container locking assemblies for engagement with cylindrical locks are disclosed. The locking assemblies include: a plate mounted on a portion of a first door, the plate having an aperture; a bracket mounted on a first side of the plate and surrounding most of a periphery of the aperture of the plate; and a tab connected to a portion of a second door, the tab having an aperture at a first end, and the tab being configured to extend through the aperture of the plate.

### CROSS-REFERENCE TO RELATED APPLICATION(S)

This application claims priority to and the benefit of U.S. Provisional Application No. 60/963,276, filed on Aug. 2, 2007, and U.S. Provisional Application No. 60/967,927, filed on Sep. 7, 2007, the entire contents of each of which are incorporated herein by reference.

### BACKGROUND OF THE INVENTION

The present invention relates generally to a locking assembly and more particularly to a shipping container locking assembly for engagement with a cylindrical lock.

Locking assemblies for use with pad-type locks have been known in the art. However, such assemblies can often be breached by using a tool such as a crowbar, a bolt cutter, or a chisel. As a result, such locking assemblies do not provide a high level of security.

To provide a higher level of protection, locking assemblies for engagement with cylindrical locks (also known as “hockey puck” locks or “puck” locks) have been used. One such lock has been described in U.S. Pat. No. 3,769,821 to Randel. As disclosed in Randel, a cylindrical lock has a cylindrical housing having at least one generally flat surface. A channel is provided on the generally flat surface, and a locking cylinder having a shaft is situated in a passageway through the cylindrical housing transverse to the channel.

As further disclosed in Randel, abutting flange ends are respectively connected to two members that are to be locked together. Each flange end has an aperture, and the apertures of the flange ends are aligned when the members are brought together. The cylindrical lock is fitted over the abutting flange ends. That is, the lock is placed over the flange ends such that the flange ends become encased within the channel of the cylindrical lock. The locking cylinder of the cylindrical lock is key-operated such that the shaft of the locking cylinder engages the aligned apertures of the abutting flange ends. As such, the two members become locked together.

Because the housing of the cylindrical lock encases both the locking cylinder and the abutting flange ends, a higher level of security is provided. That is, relative to assemblies using pad-type locks, it is more difficult to breach locking assemblies using cylindrical locks by cutting the lock open or by prying the lock from the locking assembly.

However, it is desirable to increase the structural integrity of the portion of the locking assembly that engages the shaft of the locking cylinder.

In addition, locking assemblies for engagement with cylindrical locks have been disclosed, as in, for example, U.S. Pat. No. 5,469,722 to Ellefsen (describing use of one such device on sliding doors), U.S. Pat. No. 6,233,984 to Blehi (describing use of one such device connected to a rotatable handle as part of its opening mechanism), and U.S. Pat. No. 7,047,774 to Gogel (describing use of one such device on a roll-up door). However, it is desirable to provide a locking assembly configured for use at a junction between two doors that are pivotable relative to each other, such as those of a shipping container.

Accordingly, a need exists for a locking assembly that provides an increased level of security compared to that provided by conventional locking assemblies. Preferably, the locking assembly should be configured to lock together two doors that could otherwise be swung relative to each other.

### SUMMARY OF THE INVENTION

According to one embodiment of the present invention, a shipping container comprises: a plate mounted on a portion of a first door, the plate having an aperture; a bracket mounted on a first side of the plate and surrounding most of a periphery of the aperture of the plate; and a tab connected to a portion of a second door, the tab having an aperture at a first end, and the tab being configured to extend through the aperture of the plate.

According to another embodiment of the present invention, a shipping container comprises: a first plate mounted on a portion of a first door, the first plate having an aperture; a bracket mounted on a first side of the first plate and surrounding most of a periphery of the aperture of the first plate; a second plate mounted on a portion of a second door; and a tab mounted on the second plate, the tab having an aperture at a first end, and the tab being configured to extend through the aperture of the first plate.

According to another embodiment of the present invention, a shipping container comprises: a cylindrical lock having a channel and a locking member; a plate mounted on a portion of a first door, the plate having an aperture; a bracket mounted on a first side of the plate and surrounding most of a periphery of the aperture of the plate, the bracket having an inner cylindrical surface to receive the cylindrical lock; and a tab connected to a portion of a second door. The tab has an aperture at a first end and is configured to extend through the aperture of the plate. When the first door portion and the second door portion are positioned opposite each other, the tab extends through the aperture of the plate such that the bracket at least partially surrounds the aperture of the tab, and, when the cylindrical lock is received by the bracket, the channel of the cylindrical lock receives the tab such that the aperture of the tab is engageable with the locking member of the cylindrical lock.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of a locking assembly according to an embodiment of the present invention;

FIG. 2 shows an exploded perspective view of the locking assembly of FIG. 1;

FIG. 3 shows a perspective view of a locking assembly according to an embodiment of the present invention;

FIG. 4 is a plan view of a locking assembly according to an embodiment of the present invention;

FIG. 5 is a sectional view taken along the section line 5-5 in FIG. 4;

FIG. 6 is a sectional view taken along the section line 6-6 in FIG. 4;

FIG. 7 shows a bottom partial cutaway view of a locking assembly in an unlocked position according to an embodiment of the present invention;

FIG. 8 shows a bottom partial cutaway view of a locking assembly in a locked position according to an embodiment of the present invention;

FIG. 9 shows an exemplary location for a locking assembly according to an embodiment of the present invention, with respect to doors of a shipping container;

FIG. 10 shows a perspective view of a locking assembly according to an embodiment of the present invention;

FIG. 11 shows an exploded perspective view of the locking assembly of FIG. 10;

FIG. 12 shows a perspective view of a locking assembly according to an embodiment of the present invention;

FIG. 13 is a plan view of a locking assembly according to an embodiment of the present invention;

FIG. 14 is a sectional view taken along the section line 14-14 in FIG. 13; and

FIG. 15 is a sectional view taken along the section line 15-15 in FIG. 13.

### DETAILED DESCRIPTION OF THE INVENTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

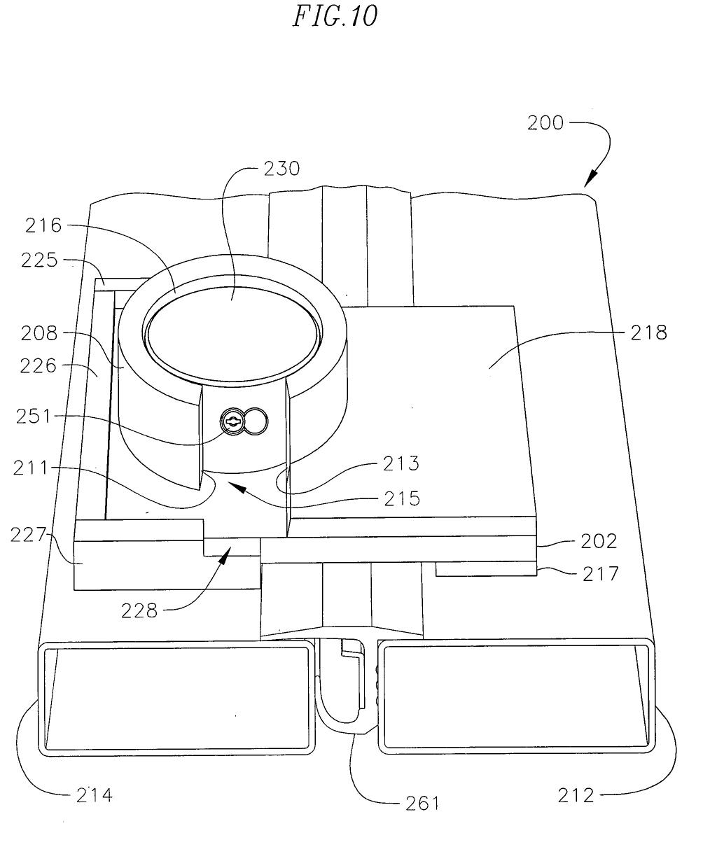

Locking assemblies according to embodiments of the present invention are attached to doors of a shipping container. When installed on a shipping container, a locking assembly according to an embodiment of the present invention is sized and configured such that International Organization for Standardization (ISO) standardized dimensions are not exceeded. That is, the locking assembly does not protrude beyond the corners of the shipping container, so that the maximum length, width, and height of the shipping container, as defined by ISO, are not exceeded. With reference to FIG. 9, a locking assembly 900 according to an embodiment of the present invention is installed at an exemplary location 904 with respect to a first door 912 and a second door 914 at an end of a shipping container 920.

When the locking assembly 900 is in a locked position, the doors 912 and 914 are locked, or secured, together. In contrast, when the locking assembly 900 is in an unlocked position, the doors 912 and 914 may be swung apart such that access to the interior of the shipping container 920 is available.

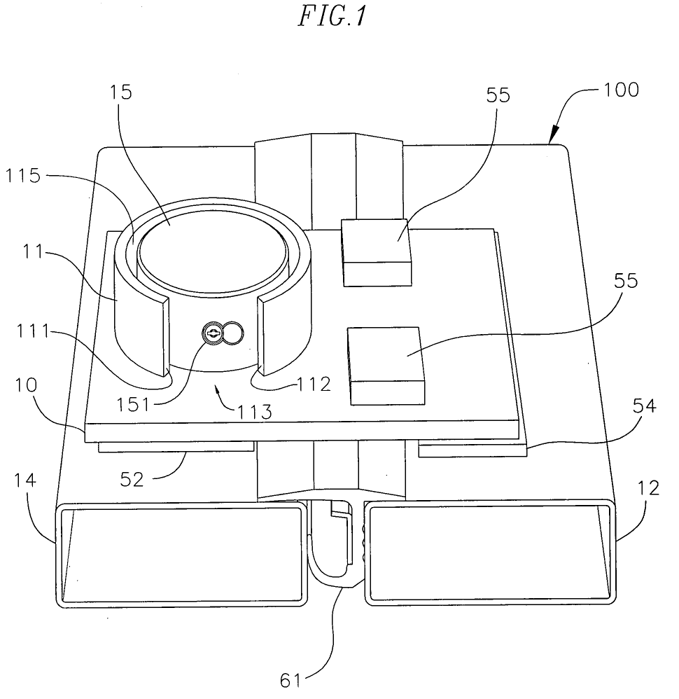

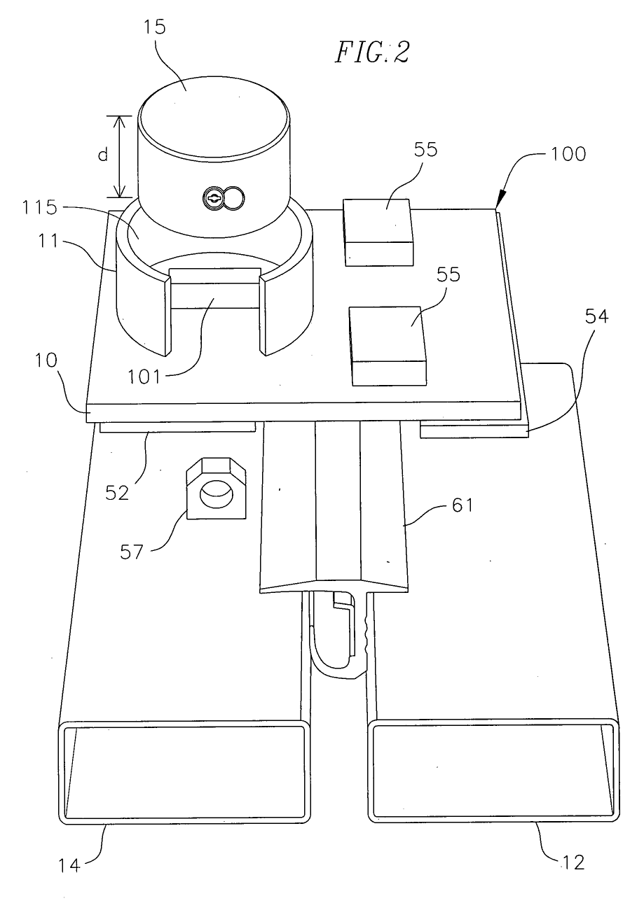

With reference to FIG. 1, a locking assembly 100 includes a plate 10 having a generally uniform thickness. The plate 10 has a generally rectangular shape, and it is formed of a sturdy and rigid material. As an example, the plate 10 may be formed of reinforced steel. With reference to FIG. 2, the plate 10 has an aperture 101 formed completely therethrough. That is, the depth of the aperture 101 corresponds to the thickness of the plate 10. As an example, the aperture 101 may be located off-center with respect to the length (i.e., the longer edge) of the plate 10. The aperture 101 may be generally rectangular in shape or any other suitable shape.

With further reference to FIG. 1, the locking assembly 100 also includes a bracket 11 having a generally uniform height. The bracket 11 has a shape of an arc (i.e., a portion of a circle), and it has a generally uniform radial thickness. The bracket 11 has two walls 111, 112 on the ends of the arc, which define an opening 113 therebetween. Additionally, the bracket 11 has an inner cylindrical surface 115. The retaining bracket 11 is formed of a sturdy and rigid material. As an example, the bracket 11 may be formed of reinforced steel.

With reference to FIGS. 1, 2, 3, and 4, the locking assembly 100 also includes stops 51, 52, each of which has a generally uniform thickness. The stops 51, 52 have a generally rectangular shape, and they may be formed of a sturdy and rigid material. As an example, the stops 51, 52 may be formed of reinforced steel.

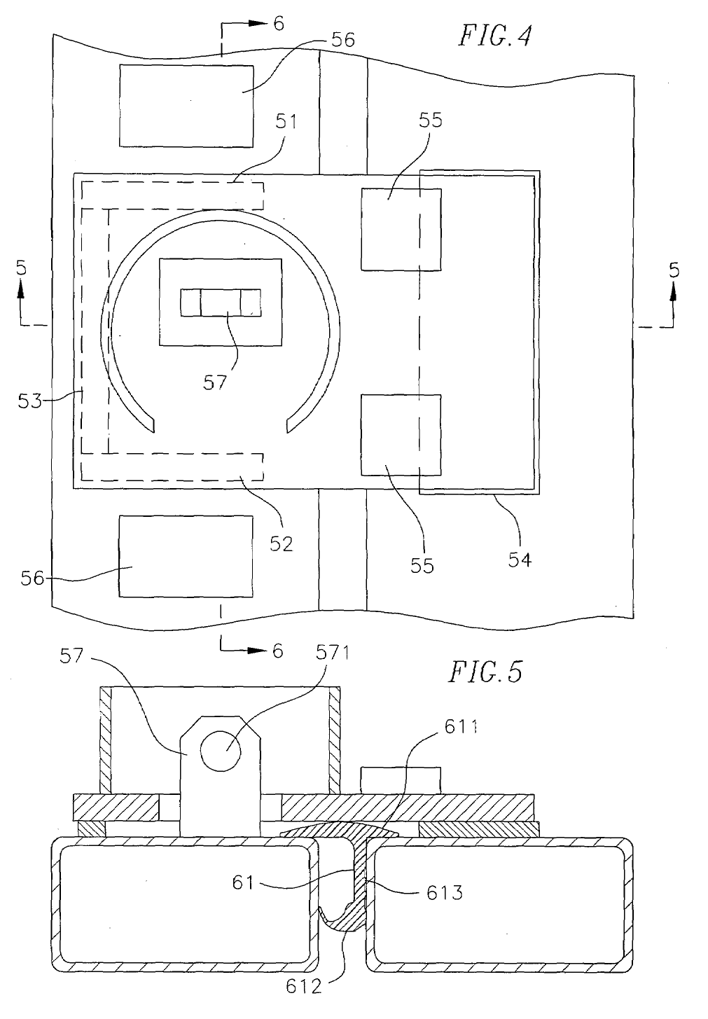

With further reference to FIG. 4, the locking assembly 100 also includes a stop 53 having a generally uniform thickness. The stop 53 has a generally rectangular shape, and the stop has a length (i.e., longer edge) that generally corresponds to the width (i.e. shorter edge) of the plate 10. The stop 53 may be formed of a sturdy and rigid material. As an example, the stop 53 may be formed of reinforced steel.

The locking assembly 100 also includes a bearing panel 54 having a generally uniform thickness. In one embodiment, the respective thicknesses of the bearing panel 54, the stops 51, 52, and the stop 53 are substantially equal to each other. The bearing panel 54 has a generally rectangular shape, and the bearing panel 54 has a length (i.e., a longer edge) that generally corresponds to the width (i.e. a shorter edge) of the plate 10. In one embodiment, the length of the bearing panel 54 is slightly larger than the width of the plate 10. The bearing panel 54 may be formed of a sturdy and rigid material. As an example, the bearing panel 54 may be formed of reinforced steel.

The locking assembly 100 may further include structures 55, each having a generally uniform thickness. The structures 55 have a generally rectangular shape, and they may be formed of a sturdy and rigid material. As an example, the structures 55 may be formed of reinforced steel.

With further reference to FIG. 4, the locking assembly 100 may further include racking brackets 56 each having a generally uniform thickness. The racking brackets 56 have a generally rectangular shape, and they may be formed of a sturdy and rigid material. As an example, the racking brackets 56 may be formed of reinforced steel.

With reference to FIGS. 2, 3, 4, and 5, the locking assembly 100 further includes a tab 57. The tab 57 may have a rectangular, semi-circular, or other suitable shape, and it has a generally uniform thickness. The tab 57 is formed of a sturdy and rigid material. As an example, the tab 57 may be formed of reinforced steel.

With further reference to FIGS. 2, 3, 4, and 5, the tab 57 has an aperture 571 extending therethrough; for example, at a right angle to the tab 57. As an example, the aperture 571 may be located off-center with respect to the height of the tab 57 (i.e., the dimension perpendicular to the surface on which the tab 57 is mounted). The aperture 571 may have a generally circular shape or any other suitable shape. The tab 57 is configured such that the tab 57 can extend through the aperture 101 of the plate 10 and such that the bracket 11 can surround the end of the tab 57 at which the aperture 571 is located.

With reference to FIGS. 1, 2, 3, and 5, the locking assembly 100 may further include a resilient gasket 61. The gasket 61 has two generally curved portions 611, 612 joined by a generally level portion 613. The resilient gasket 61 is formed of a flexible material. For example, the resilient gasket 61 may be formed of rubber.

The locking assembly 100 is configured to be used with a cylindrical lock 15. In one embodiment, the locking assembly 100 is configured to be used with a cylindrical lock of a type disclosed in U.S. Pat. No. 3,769,821, to Randel, the content of which is incorporated by reference.

In more detail, the cylindrical lock 15 has a housing having a substantially round outer surface. The outer diameter of the cylindrical lock 15 is smaller than the diameter of the inner cylindrical surface 115 of the bracket 11. Additionally, the cylindrical lock 15 has a thickness d defined as the distance between its two generally flat ends (see, for example, FIG. 2). In one embodiment, the thickness d of the cylindrical lock 15 is substantially equal to or less than a height of the bracket 11. In such a configuration, the cylindrical lock 15 will not protrude from the bracket 11 and, as a result, will be less likely to be damaged.

To withstand blows from tools such as a hammer or the like, the housing of the cylindrical lock 15 may be constructed out of a hard and durable material, such as steel or aluminum or the like.

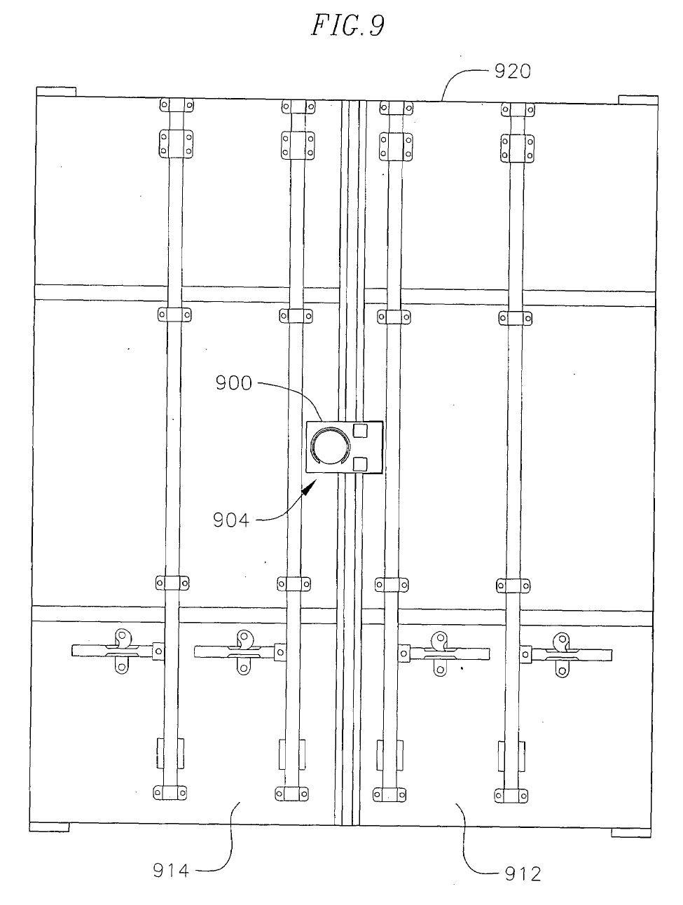

With reference to FIGS. 7 and 8, at one of the generally flat ends, the housing of the cylindrical lock 15 has a generally rectangular channel 152 extending at least partially through the cylindrical lock 15. A longitudinal passageway 153 substantially perpendicular to the channel 152 extends from the round outer surface to at least the channel 152.

The cylindrical lock 15 has a locking member 154 that is fixedly mounted within the housing of the cylindrical lock and slidable within the passageway 153. A keyway 151 (shown in FIG. 1) extends longitudinally along the locking member 154, extending from an outer end of the locking member 154 and continuing through most of the locking member 154 but not reaching the inner end of the locking member 154. A pin securably connected to the housing of the cylindrical lock 15 extends into the keyway 151 to prevent the locking member 154 from completely sliding out of the housing.

Coupled to the inner end of the locking member 154 is a bolt 155 having a radial diameter smaller than the diameter of the aperture 571 of the tab 57.

In assembly, the bracket 11 is mounted on a first side of the plate 10. The bracket 11 is mounted such that the bracket 11 surrounds most of a periphery of the aperture 101 of the plate 10. That is, the bracket 11 surrounds more than half of a periphery of the aperture 101 of the plate 10, the opening 113 between the two walls 111, 112 being only as wide as needed to fit a suitable key for the cylindrical lock 15. As an example, the bracket 11 may be mounted on the plate 10 by welding. Here, the bracket 11 serves to guide and maintain the positioning of the cylindrical lock 15 on the plate 10 and to hinder unauthorized removal of the cylindrical lock 15 from the plate 10.

The stops 51, 52, 53 are mounted on a second side of the plate 10, the second side being opposite the first side. The stops 51, 52 are mounted to extend along the length of the plate 10 near the aperture 101. The stop 53 is mounted to extend along the width of the plate 10 near the aperture 101. Here, the stops 51, 52, 53 serve to define a certain clearance between the plate 10 and a portion of a door 14 in contact with the plate 10. In addition, the stops 51, 52, 53 hinder unauthorized removal of the plate 10 from a surface on which the plate 10 is mounted.

The bearing panel 54 is mounted on the second side of the plate 10 to extend along the width of the plate 10. Here, similar to the stops 51, 52, 53, the bearing panel 54 serves to define a certain clearance between the plate 10 and a portion of a door 12 to which the plate 10 is attached. In addition, the bearing panel 54 hinders unauthorized removal of the plate 10 from a surface on which the plate 10 is mounted.

The structures 55 are mounted on the first side of the plate 10 away from the aperture 101 of the plate 10. That is, the structures 55 are mounted on the plate 10 to be adjacent to the bracket 11. Combined with the bearing panel 54, the structures 55 serve to lend additional bulk and/or thickness to the plate 10.

In one embodiment, with reference to FIG. 1, the plate 10 is mounted on a portion of a first door 12 (e.g., a first door bracket, a first door railing) via the bearing panel 54. That is, the bearing panel 54 is mounted on the first door portion 12 such that the plate 10 is affixed to the first door portion 12 and the second side of the plate 10 is positioned opposite the first door portion 12.

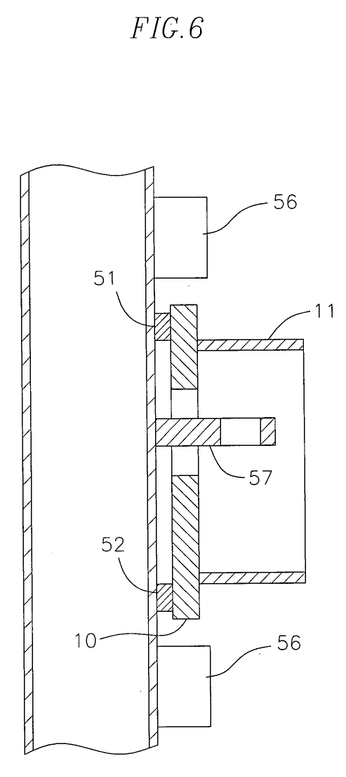

With reference to FIGS. 1 and 5, the gasket 61 is affixed to the first door portion 12. In more detail, the generally level portion 613 of the gasket 61 is affixed to the first door portion 12. In one embodiment, the gasket 61 is affixed to the first door portion 12 using glue or any other suitable adhesive. With reference to FIG. 5, curved portion 611 is partially wedged into a space defined by the first door portion 12, the bearing panel 54 and the plate 10.

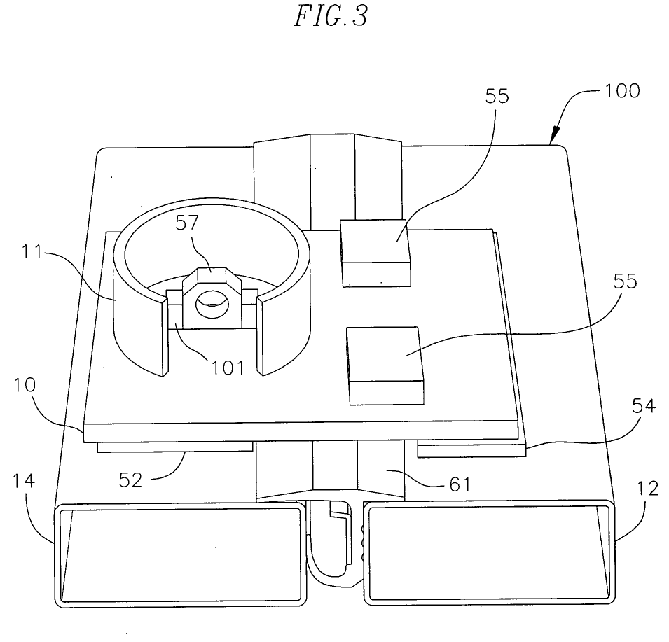

With reference to FIG. 2, the tab 57 is mounted on a portion of a second door 14 (e.g., a second door bracket). In more detail, with reference to FIG. 3, the tab 57 is mounted at a location of the second door portion 14 such that the tab 57 extends through the aperture 101 of the plate 10 when the first and second door portions 12, 14 are brought together to form a juncture.

The first and second door portions 12, 14 are brought together such that the tab 57 extends through the aperture 101 of the plate 10 and such that the aperture 571 of the tab 57 is surrounded by the bracket 11. Further, the stops 51, 52, 53 are positioned between the second door portion 14 and the plate 10 such that the second side of the plate 10 is positioned opposite the second door portion 14. With reference to FIG. 5, curved portion 611 of the gasket 61 is partially wedged into a space defined by the second door portion 14, the tab 57 and the plate 10. Curved portion 612 of the gasket 61 comes into contact with (and may be compressed by) the second door portion 14. As such, the gasket 61 serves as a cushioning, or force-absorbing, device when the first and second door portions 12, 14 are brought together. In addition, when the locking assembly 100 is installed on a container, the gasket 61 helps to seal the interior of the container from the exterior.

As such, a closed arrangement of the first and second door portions 12, 14 is defined.

With reference to FIG. 4, in one embodiment, one or more racking brackets 56 are mounted on the second door portion 14 to be adjacent to the plate 10 and, more specifically, the bracket 11. The racking brackets 56 are mounted to provide upwards and downwards racking protection. For example, the racking brackets 56 reduce the likelihood that doors (or door portions) of a shipping container on which the locking assembly is mounted will flex when the container is placed on an uneven surface. Additionally, the racking brackets 56 also provide additional protection against attempts to breach the locking assembly using a crowbar and the like.

With reference to FIGS. 1, 7, and 8, to secure the closed arrangement of the first and second door portions 12, 14, the cylindrical lock 15 is positioned on the plate 10 to be partially encased by the bracket 11. In turn, the channel 152 of the cylindrical lock 15 encases the tab 57. Further, the keyway 151 of the cylindrical lock 15 is positioned at the opening 113 defined between the two walls 111, 112 of the bracket 11. Because the bracket 11 substantially surrounds the cylindrical lock 15, the bracket 11 inhibits movement of the cylindrical lock 15 along the length and width of the plate 10 and protects the cylindrical lock 15 from attempts to pry it off from the plate 10.

With further reference to FIGS. 1, 7, and 8, a key is inserted into the keyway 151. The locking member 154 is inserted into the housing of the cylindrical lock 15 such that the outer end of the locking member 154 becomes generally flush with the curved outer surface of the lock housing. Accordingly, with reference to FIG. 8, the bolt 155 of the locking member 154 becomes engaged with the aperture 571 of the tab 57. As such, the first and second door portions 12, 14 are secured together. That is, the lock 15 is restrained from being lifted off the plate 10 due to the engagement between the bolt 155 and the aperture 571 of the tab 57. As a result, the first and second door portions 12, 14 cannot be swung relative to one another. The key is rotated counter-clockwise approximately 90 degrees, and the key is then removed from the keyway 151.

To unlock the locking assembly, the key is inserted into the keyway 151. The key is rotated clockwise approximately 90 degrees, and then the locking member 154 may be pulled away from the lock housing. As such, with reference to FIG. 7, the bolt 155 becomes disengaged with the aperture 571 of the tab 57, and the cylindrical lock 15 can then be lifted away from the confines of the bracket 11 and off the plate 10. The first and second door portions 12, 14 can then be moved away from one another.

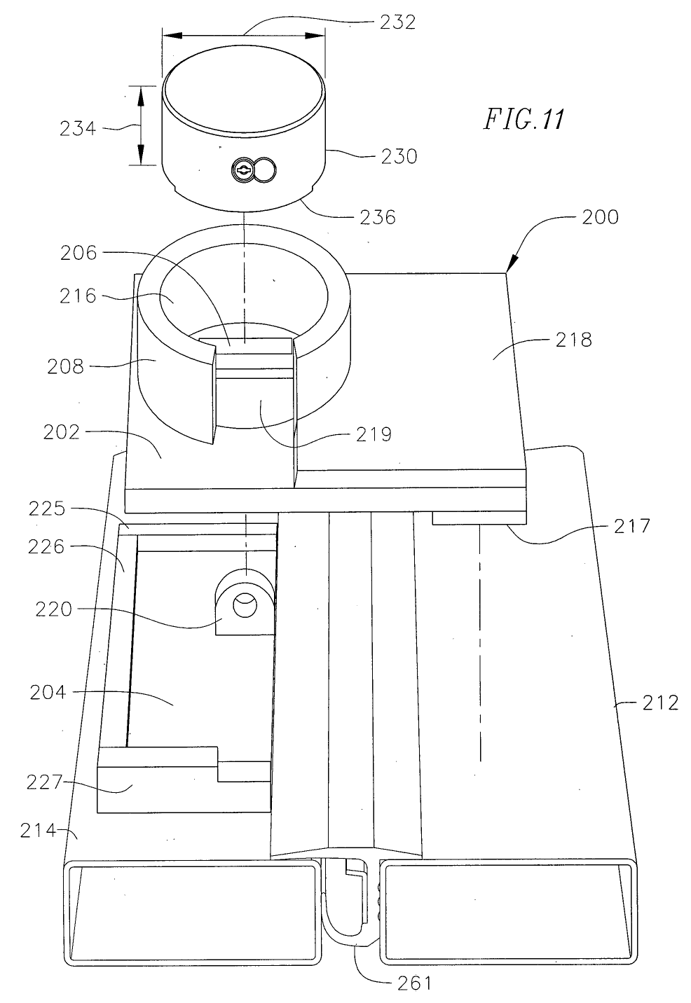

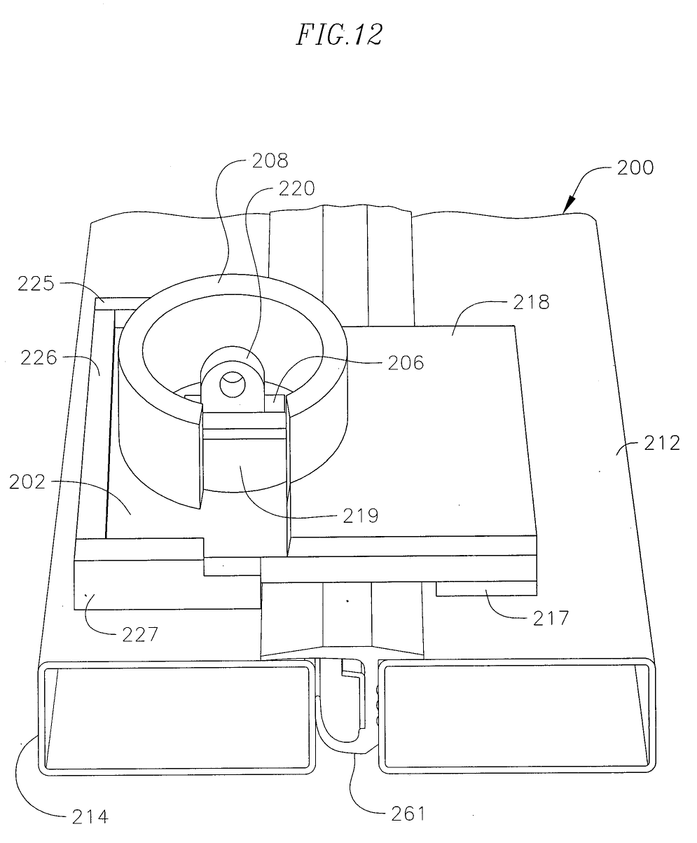

FIGS. 10-15 show various views of a locking assembly 200 according to another embodiment of the present invention. With reference to FIGS. 10 and 11, a locking assembly 200 includes a first plate 202 and a second plate 204. FIGS. 10, 13, and 14 show the locking assembly 200 in an engaged position with the first plate 202 resting on top of the second plate 204.

The first plate 202 has a generally rectangular shape and a generally uniform thickness. The first plate 202 may be formed of a sturdy and rigid material. As an example, the first plate 202 may be formed of reinforced steel. With reference to FIG. 11, the first plate 202 has an aperture 206 formed completely through the thickness of the first plate 202. As an example, the aperture 206 may be located off-center with respect to the length (i.e., the longer edge) of the first plate 202. The aperture 206 may be generally rectangular in shape or any other suitable shape.

With further reference to FIG. 10, the locking assembly 200 also includes a bracket 208 having a generally uniform height 210 (shown in FIG. 15). The bracket 208 has a shape of an arc (i.e., a portion of a circle), and it has a generally uniform radial thickness. The bracket 208 has two walls 211, 213 on the ends of the arc, which define an opening 215 therebetween. Additionally, the bracket 208 has an inner cylindrical surface 216. The bracket 208 is formed of a sturdy and rigid material. As an example, the bracket 208 may be formed of reinforced steel.

The locking assembly 200 also includes a bearing panel 217 having a generally uniform thickness. The bearing panel 217 has a generally rectangular shape, and the bearing panel 217 has a length (i.e., a longer edge) that generally corresponds to the width (i.e. a shorter edge) of the first plate 202. The bearing panel 217 may be formed of a sturdy and rigid material. As an example, the bearing panel 217 may be formed of reinforced steel.

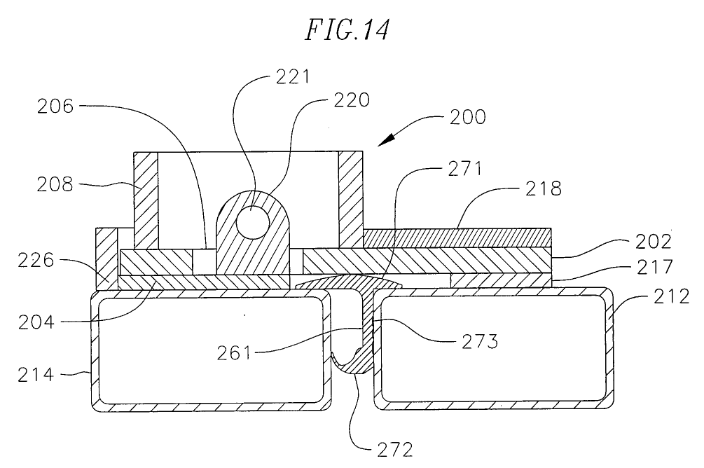

The locking assembly 200 may further include a stiffening panel 218 having a generally uniform thickness. The stiffening panel 218 has a generally rectangular shape with a cutout in the shape of an arc having a diameter approximately equal to the outer diameter of the bracket 208 (see, for example, FIG. 13). The stiffening panel 218 may be formed of a sturdy and rigid material. As an example, the stiffening panel 218 may be formed of reinforced steel.

Additionally, with reference to FIG. 11, the locking assembly 200 may include a recessed level 219 within the bracket 208. The recessed level 219 is generally flat and formed of a sturdy and rigid material, such as reinforced steel.

With reference to FIG. 11, the second plate 204 has a generally rectangular shape and a generally uniform thickness. In one embodiment, the respective thicknesses of the second plate 204 and the bearing panel 217 are substantially equal to each other. The second plate 204 may be formed of a sturdy and rigid material. As an example, the second plate 204 may be formed of reinforced steel.

With further reference to FIG. 11, the locking assembly 200 also includes a tab 220. The tab 220 may have a rectangular, semi-circular, or other suitable shape, and it has a generally uniform thickness. The tab 220 is formed of a sturdy and rigid material. As an example, the tab 220 may be formed of reinforced steel.

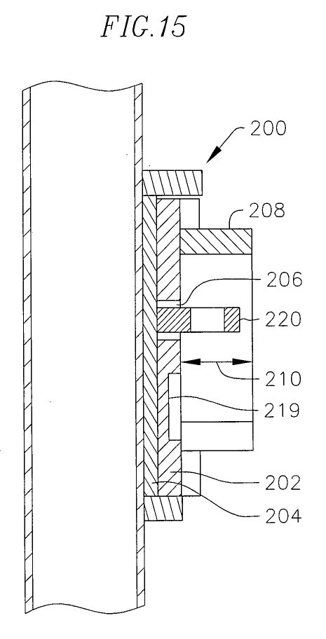

With reference to FIG. 14, the tab 220 has an aperture 221 extending therethrough; for example, at a right angle to the tab 220. As an example, the aperture 221 may be located off-center with respect to the height of the tab 220 (i.e., the dimension perpendicular to the surface of the second plate 204 on which the tab 220 is mounted). The aperture 221 may have a generally circular shape or any other suitable shape. The tab 220 is configured such that the tab 220 can extend through the aperture 221 of the first plate 202 and such that the bracket 208 can surround the end of the tab 220 at which the aperture 221 is located.

With reference to FIG. 10, the locking assembly 200 also includes walls 225, 226, and 227, each of which has a generally uniform thickness. The walls 225, 226, and 227 have a generally rectangular shape, and they may be formed of a sturdy and rigid material. As an example, the walls 225, 226, and 227 may be formed of reinforced steel. The wall 227 has a notch 228.

With reference to FIGS. 10, 11, 12, and 14, the locking assembly 200 may further include a resilient gasket 261. The gasket 261 has two generally curved portions 271, 272 joined by a generally level portion 273. The resilient gasket 261 is formed of a flexible material. For example, the resilient gasket 261 may be formed of rubber.

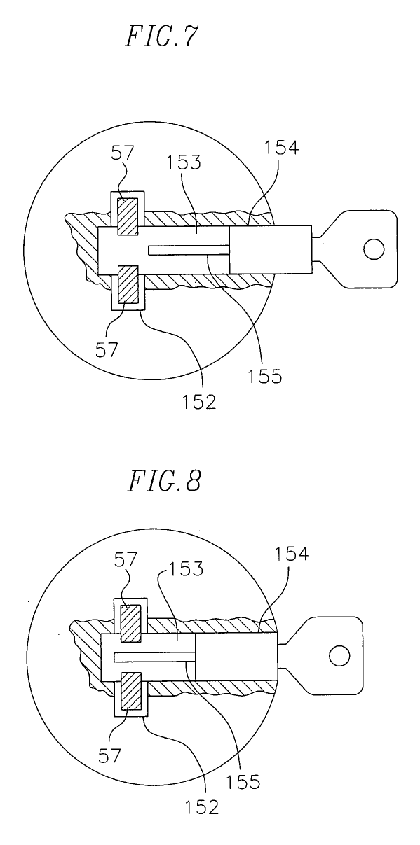

The locking assembly 200 is configured to be used with a cylindrical lock 230, such as the lock previously described in connection with FIGS. 1-9. The cylindrical lock 230 has a housing having a substantially round outer surface and an outer diameter 232 (see FIG. 11). The outer diameter 232 of the cylindrical lock 230 is smaller than the diameter of the inner cylindrical surface 216 of the bracket 208. Additionally, the cylindrical lock 230 has a thickness 234 defined as the distance between its two generally flat faces (see FIG. 11). In one embodiment, the thickness 234 of the cylindrical lock 230 is substantially equal to or less than the height 210 (see FIG. 15) of the bracket 208. As depicted in FIG. 11, the cylindrical lock 230 also has a raised feature 236 on its bottom face. The raised feature 236 extends around a portion of the perimeter of the cylindrical lock 230 and has a uniform thickness.

In assembly, the bracket 208 is mounted on a first side of the first plate 202. The bracket 208 is mounted such that the bracket 208 surrounds most of a periphery of the aperture 206 of the first plate 202. That is, the bracket 208 surrounds more than half of a periphery of the aperture 206 of the first plate 202, the opening 215 between the two walls 211, 213 being only as wide as needed to fit a suitable key for the cylindrical lock 230. As an example, the bracket 208 may be mounted on the first plate 202 by welding. Here, the bracket 208 serves to guide and maintain the positioning of the cylindrical lock 230 on the first plate 202 and to hinder unauthorized removal of the cylindrical lock 230 from the first plate 202.

The bearing panel 217 is mounted on the second side of the first plate 202 to extend along the width of the first plate 202. As an example, the bearing panel 217 may be mounted on the first plate 202 by welding. The bearing panel 217 serves to define a certain clearance between the first plate 202 and a portion of a first door 212 to which the first plate 202 is attached. In addition, the bearing panel 217 hinders unauthorized removal of the first plate 202 from a surface on which the first plate 202 is mounted.

The stiffening panel 218 is mounted on the first side of the first plate 202 away from the aperture 206 of the first plate 202. That is, the stiffening panel 218 is mounted on the first plate 202 adjacent to the bracket 208 and on the same end as the bearing panel 217, such that the arc-shaped cutout of the stiffening panel 218 fits around a portion of the outer diameter of the bracket 208 (see, for example, FIG. 13). As an example, the stiffening panel 218 may be mounted on the first plate 202 by welding. In addition, the stiffening panel 218 may be welded to the bracket 208. Together with the bearing panel 217, the stiffening panel 218 serves to provide additional strength and/or stiffness to the first plate 202.

The top of the recessed level 219, in assembly, is lower than the first side of the first plate 202. The recessed level 219 may be welded to one or both of the first plate 202 and the bracket 208.

As part of the present invention, the first plate 202, the bracket 208, the bearing panel 217, and the stiffening panel 218 (or any combination thereof) may be machined, cast, or otherwise formed from a common source of material, rather than initially being formed as separate components of the locking assembly 200, as described above. Alternatively, each component may be formed from sub-components. For example, a portion of the first plate 202, such as the circular portion within the bracket 208 or the recessed level 219, may be formed as a separate sub-component and later welded or otherwise attached to the first plate 202 or bracket 208 in order to form a complete first plate 202.

In one embodiment, with reference to FIG. 10, the first plate 202 is mounted on a portion of a first door 212 (e.g., a first door bracket or a first door railing) via the bearing panel 217. That is, the bearing panel 217 is mounted on the first door portion 212 such that the first plate 202 is affixed to the first door portion 212 and the second side of the first plate 202 is positioned opposite the first door portion 212. As an example, the bearing panel 217 may be mounted on the first door portion 212 by welding.

With reference to FIGS. 10 and 14, the gasket 261 is affixed to the first door portion 212. In more detail, the generally level portion 273 of the gasket 261 is affixed to the first door portion 212. In one embodiment, the gasket 261 is affixed to the first door portion 212 using glue or any other suitable adhesive. With reference to FIG. 14, curved portion 271 is partially wedged into a space defined by the first door portion 212, the bearing panel 217 and the first plate 202.

The tab 220 is mounted on the first side of the second plate 204 by any suitable means. For example, the tab 220 may be welded to the second plate 204.

The walls 225, 226, 227 are mounted on the outside faces of the second plate 204, the outside faces being perpendicular to the first side. As an example, the walls 225, 226, 227 may be mounted on the second plate 204 by welding. The walls 225, 226, 227 serve to define the alignment of the first plate 202 with the second plate 204. In addition, the walls 225, 226, 227 strengthen and stiffen the second plate and hinder unauthorized removal of the second plate 204 from a surface on which the second plate 204 is mounted.

As part of the present invention, the second plate 204, the tab 220, and the walls 225, 226, 227 (or any combination thereof) may be machined, cast, or otherwise formed from a common source of material, rather than initially being formed as separate components of the locking assembly 200, as described above.

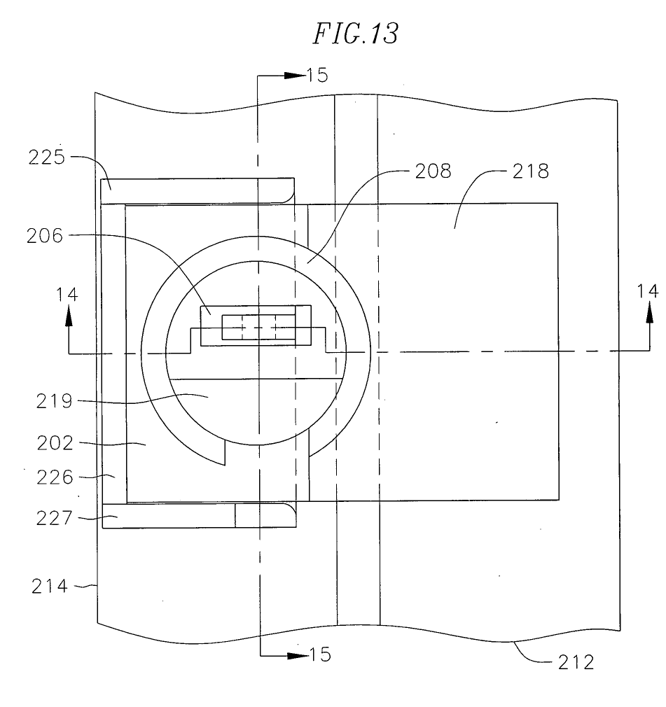

With reference to FIG. 11, the second plate 204 is mounted on a portion of a second door 214 (e.g., a second door bracket). In more detail, with reference to FIG. 12, the second plate 204 is mounted at a location of the second door portion 214 such that the tab 220 extends through the aperture 206 of the first plate 202 when the first and second door portions 212, 214 are brought together to form a juncture. As an example, the second plate 204 may be mounted on the second door portion 214 by welding.

The first and second door portions 212, 214 are brought together such that the tab 220 extends through the aperture 206 of the first plate 202 and such that the aperture 221 of the tab 220 is surrounded by the bracket 208. Further, the walls 225, 226, 227 are positioned to accept the first plate 202 such that the second side of the first plate 202 is positioned opposite and resting on the first side of the second plate 204. With reference to FIG. 14, curved portion 271 of the gasket 261 is partially wedged into a space defined by the second door portion 214, the second plate 204 and the first plate 202. Curved portion 272 of the gasket 261 comes into contact with (and may be compressed by) the second door portion 214. As such, the gasket 261 serves as a cushioning, or force-absorbing, device when the first and second door portions 212, 214 are brought together. In addition, when the locking assembly 200 is installed on a container, the gasket 261 helps to seal the interior of the container from the exterior.

As such, a closed arrangement of the first and second door portions 212, 214 is defined.

With reference to FIGS. 10 and 11, to secure the closed arrangement of the first and second door portions 212, 214, the cylindrical lock 230 is positioned on the first plate 202 to be partially encased by the bracket 208. The recessed level 219 may provide clearance for the raised feature 236 on the bottom of the cylindrical lock 230. By recessing the raised feature 236 of the cylindrical lock 230 below the surface of the first side of the first plate 202, it will be more difficult to pry off the cylindrical lock 230 via the opening 215. Further, the keyway 251 of the cylindrical lock 230 is positioned at the opening 215 defined between the two walls 211, 213 of the bracket 208, as well as at the corresponding notch 228 in the wall 227. The engagement and disengagement of the cylindrical lock 230 with the tab 220 is as described previously in connection with FIGS. 1-9.

Although embodiments of the present invention have been described with reference to a cylindrical lock of a type disclosed in U.S. Pat. No. 3,769,821 to Randel, it will be appreciated by individuals skilled in the art that the locking assembly according to embodiments of the present invention can be used with other types of cylindrical locks that are known in the art.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the claims supported by this application and their equivalents, rather than the foregoing description.

What is claimed is:

1. A shipping container comprising:
a plate mounted on a portion of a first door, the plate having an aperture;
a bracket mounted on a first side of the plate and surrounding most of a periphery of the aperture of the plate; and
a tab connected to a portion of a second door, the tab having an aperture at a first end, and the tab being configured to extend through the aperture of the plate.

2. The shipping container of claim 1,
wherein the bracket is configured to retain a cylindrical lock having a channel configured to receive the tab.

3. The shipping container of claim 1,
wherein the tab is a one-piece structure.

4. The shipping container of claim 1, wherein:
the shipping container further comprises a second plate; and
the tab is mounted on a first side of the second plate.

5. A shipping container comprising:
a cylindrical lock having a channel and a locking member;
a plate mounted on a portion of a first door, the plate having an aperture;
a bracket mounted on a first side of the plate and surrounding most of a periphery of the aperture of the plate, the bracket having an inner cylindrical surface to receive the cylindrical lock; and
a tab connected to a portion of a second door, the tab having an aperture at a first end, and the tab being configured to extend through the aperture of the plate;
wherein, when the first door portion and the second door portion are positioned opposite each other, the tab extends through the aperture of the plate such that the bracket at least partially surrounds the aperture of the tab, and, when the cylindrical lock is received by the bracket, the channel of the cylindrical lock receives the tab such that the aperture of the tab is engageable with the locking member of the cylindrical lock.

6. The shipping container of claim 5, wherein:
the tab is a one-piece structure; and
the tab is connected to the portion of the second door by mounting the tab on the portion of the second door.

7. The shipping container of claim 5, wherein:
the shipping container further comprises a second plate;
the tab is mounted on a first side of the second plate; and
the tab is connected to the portion of the second door by mounting the second plate on the portion of the second door.
